(19) United States
(12) Patent Application Publication
(10) Pub. No.: US 2018/0324356 A1
(43) Pub. Date: Nov. 8, 2018

(54) EXTENDED VISUAL CAPTURE IN A RECONFIGURABLE SERVICE

(71) Applicant: INTEL CORPORATION, Santa Clara, CA (US)

(72) Inventors: Rajiva K. Sarraju, Portland, OR (US); Joshua L. Zuniga, Damascus, OR (US); Aleksander Magi, Portland, OR (US); David W. Browning, Portland, OR (US); Audrey C. Younkin, Hillsboro, OR (US); Saara Kamppari-Miller, Portland, OR (US); Phil Riehl, Hillsboro, OR (US); Guy Therien, Beaverton, OR (US)

(73) Assignee: INTEL CORPORATION, Santa Clara, CA (US)

(21) Appl. No.: 15/773,969

(22) PCT Filed: Nov. 16, 2015
(86) PCT No.: PCT/US15/60844

§ 371 Date: May 4, 2018

(51) Int. Cl. H04N 5/232; H04N 5/247; G06F 1/16; H04N 5/225

(52) U.S. Cl. CPC H04N 5/23245; H04N 5/23296; H04N 5/232945; H04N 5/2258; G06F 1/1641; G06F 1/1677; G06F 1/1686; H04N 5/247

(57) ABSTRACT

The present disclosure pertains to extended visual capture in a reconfigurable device. In general, at least a display portion of a device may have a deformable shape configuration in that its shape is changeable by a user. The device may also comprise at least sensor circuitry including a plurality of sensors. The shape configuration may position the plurality of sensors at different positions to enable extended visual capture of a 180 to 360 degree viewing range surrounding the device in a single image or video. Control circuitry in the device may determine when shape reconfiguration of at least the display has occurred, determine whether the new shape configuration involves visual capture, and if the new shape configuration is determined to involve visual capture, determine an operational mode for the at least the sensor circuitry and cause the sensor circuitry to capture visual data based at least on the operational mode.

### TECHNICAL FIELD

This disclosure relates to visual capture, and more particularly, to a device capable of at least visual capture over a wide expanse based on a shape configuration of the device.

### BACKGROUND

Advances in electronics and wireless communications have led to the proliferation of mobile devices. Mobile devices have evolved from simple analog handsets for supporting voice communications to powerful handheld computers capable of carrying out various tasks. Activities that were typically only performed in person, with specialized equipment, etc., may now be carried out utilizing mobile devices including, but not limited to, smart phones, tablet computers, laptop computers, etc. Example activities may include personal communications such as social media interactions, business-related communications, appointment scheduling, financial and consumer transactions, productivity applications, streaming of multimedia data for business or entertainment, playing games, location determination and/or navigation, etc.

However, this array of functionality is only the beginning. Consumers are driving a continuous demand for new and improved functionality. Various utilities and applications that employ visual capture (e.g., image and/or video recording) have made this functionality indispensable in mobile devices. In this regard, manufacturers continue to upgrade the visual capture capabilities of mobile devices to meet customer demand Higher quality visual data may be captured utilizing, for example, improved resolution image sensor components, more advanced image processing, higher power flash components, etc. However, mobile devices are unavoidably limited in space. As a result, despite these advancements in image quality, the field of view is often substantially limited based on the small size of the camera included in a mobile device. In addition to limiting the size of the images and video that are captured, the small field of view limits the applications to which visual capture may be applied such as, for example, video conferencing, capturing live action events, etc. Attempts to capture larger areas may involve a user manually moving the device camera across an area to be recorded to capture multiple images that are combined to generate a single panoramic image. However, the motion required during this type of manual operation may result in poor image quality, and may further result in timing issues that cause events that occur contemporaneously but at different locations outside of the field of view of the visual capture equipment to be missed.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example reconfigurable device for extended visual capture in a tablet configuration, mobile configuration and inactive configuration in accordance with at least one embodiment of the present disclosure;

FIG. 2 illustrates an example configuration for a device usable in accordance with at least one embodiment of the present disclosure;

FIG. 3 illustrates an example reconfigurable device for extended visual capture in a first extended visual capture configuration in accordance with at least one embodiment of the present disclosure;

FIG. 4 illustrates an example reconfigurable device for extended visual capture in a second extended visual capture configuration in accordance with at least one embodiment of the present disclosure;

FIG. 5 illustrates an example of extended visual capture using a reconfigurable device in accordance with at least one embodiment of the present disclosure;

FIG. 6 illustrates an example implementation of a device in accordance with at least one embodiment of the present disclosure; and

FIG. 7 illustrates example operations for extended visual capture in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

The present disclosure pertains to extended visual capture in a reconfigurable device. In general, at least a display portion of a device may have a deformable shape configuration in that its shape is changeable by a user. The device may also comprise at least sensor circuitry including a plurality of sensors (e.g., cameras). The shape configuration may position the plurality of sensors at different positions to enable extended visual capture. For example, an extended visual capture may range from a 180 degree viewing range surrounding the device captured in a single image or video to a full 360 degrees. Control circuitry in the device may be able to determine when shape reconfiguration of at least the display has occurred and determine whether the new shape configuration involves visual capture. If the control circuitry determines that the new shape configuration involves visual capture, the control circuitry may then determine an operational mode for the at least the sensor circuitry and cause the sensor circuitry to capture visual data based at least on the operational mode. Consistent with the present disclosure, the control circuitry may also be capable of configuring the display based on the operational mode and causing at least the display to present the visual data when the new shape configuration does not involve visual capture but follows a previous shape configuration that involved visual capture.

In at least one embodiment, a visual data capture device may comprise, for example, at least a display, sensor circuitry and control circuitry. The display may be deformable and have a shape configuration. The sensor circuitry may be to capture at least visual data. The control circuitry may be to determine that the display has changed to a new shape configuration, determine if the new shape configuration involves visual data capture and, based on a determination that the new shape configuration involves visual data capture, determine an operational mode for at least the sensor circuitry based on the new shape configuration and cause the sensor circuitry to capture visual data based at least on the operational mode.

In at least one embodiment, a shape configuration may comprise at least a first portion of the display being oriented relative to a second portion of the display. At least the display may be flexible. The display may also be segmented into portions, the portions being at least structurally coupled to allow the display portions to move relative to each other. An example new shape configuration may comprise at least two opposing end portions of the display folded away from a center of a presentation surface of the display so that at least the display becomes substantially columnar in shape with the presentation surface visible on an outer surface of the columnar shape. Another example new shape configuration may comprise at least two opposing end portions of the display folded towards a center of a presentation surface of the display so that the presentation surface is visible on the interior of the folded display.

In at least one embodiment, the sensor circuitry may comprise a plurality of sensors. The plurality of sensors may comprise at least cameras. The operational mode may be to, for example, cause certain sensors in the plurality of sensors to capture the visual data based on the shape configuration. The certain sensors may be mounted to a surface of the display, the certain sensors being positioned for visual data capture by deforming the display. The shape configuration of at least the display may cause the plurality of sensors to be positioned with respect to each other to capture visual data corresponding to at least a 180 degree viewing range surrounding the device. Alternatively, the shape configuration of at least the display may cause the plurality of sensors to be positioned with respect to each other to capture visual data corresponding to substantially a 360 degree viewing range surrounding the device. The control circuitry may also be to configure operation of the display based on the operational mode. Consistent with the present disclosure, an example method for controlling a visual data capture device may comprise determining that a deformable display having a shape configuration in a device has changed to a new shape configuration, determining if the new shape configuration involves visual data capture, and based on a determination that the new shape configuration involves visual data capture, configuring an operational mode for at least sensor circuitry in the device based on the shape configuration and causing the sensor circuitry to capture the visual data based on the operational mode.

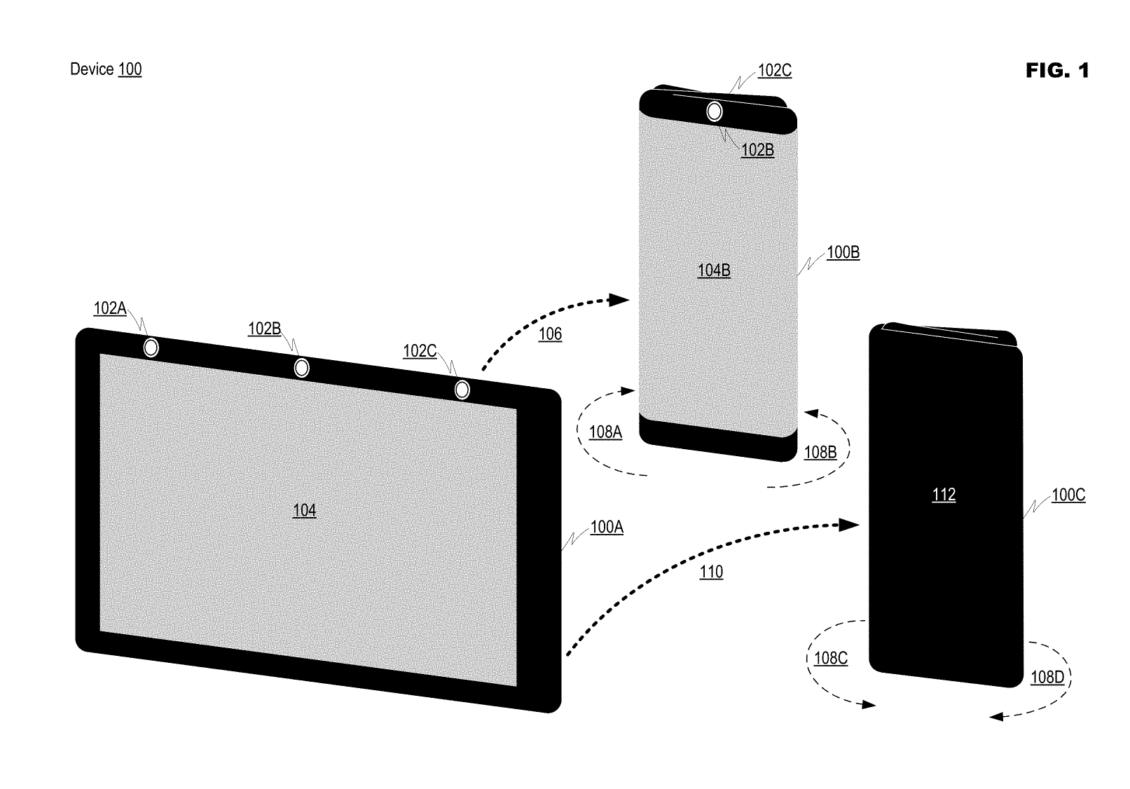

FIG. 1 illustrates an example reconfigurable device for extended visual capture in a tablet configuration, mobile configuration and inactive configuration in accordance with at least one embodiment of the present disclosure. In describing embodiments consistent with the present disclosure, reference may be made to technologies such as, for example, flexible substrate circuits, flexible displays, visual capture, etc. These examples have been utilized to provide a readily comprehensible perspective for understanding the disclosed embodiments, and are not intended to limit implementations to only using these technologies. Moreover, the inclusion of an apostrophe after an item number in a figure (e.g., 100') is to indicate that an example embodiment of the item is being illustrated. The example embodiments are not intended to limit the disclosure to only what is shown, and are presented merely for the sake of explanation. As referenced herein, “visual capture” may include any type of recording of visual data including, for example, capturing or streaming of individual images or video, etc. “Extended visual capture” may occur over a wider visible area than basic visual capture. For example, if a typical device camera captures a 40 to 60 degree view, extended visual capture may capture at least a 180 degree view and up to a full 360 degree view surrounding a device.

Consistent with the present disclosure, an example device (generally, “device 100”) is illustrated in three configurations including tablet configuration 100A, mobile configuration 100B and inactive configuration 100C. In transforming device 100 from tablet configuration 100A to either of mobile configuration 100B (e.g., as shown at 106) or inactive configuration 100C (e.g., as shown at 110), the shape of at least display 104 is reconfigured (e.g., by a user) into a new shape configuration. Shape reconfiguration may include, for example, twisting, bending, folding deforming, etc. display 104 so that the shape changes in that at least a first portion of display 104 is repositioned in regard to at least a second portion of display 104. Display 104 may utilize a variety of reconfigurable technologies that allow it progress through shape reconfiguration without breaking. For example, display 104 may be manufactured using flexible substrate circuit technology that allows display 104 to bend, twist, fold, etc. almost as if the substrate was actually made of paper, fabric, etc. In another example, display 104 may be based on traditional rigid substrate circuit technology. A rigid display 104 may be segmented into portions with each portion at least mechanically coupled via hinges (e.g., similar to the movable assembly employed between a laptop screen and keyboard), a flexible hinge-like material, etc. The rigid portions of display 104 may not fold or deform, but the hinges allow the portions to be mechanically reconfigured relative to each other to transform device 100 between different configurations such as illustrated at 106 and 110 in FIG. 1. Moreover, while at least display 104 is deformable (e.g., may have a deformable shape configuration), some components, electronic circuitry, housings, etc. of device 100 may not. For example, a flexible display 104 may fold out from a rigid hardware base or platform. However, it is also possible for all of device 100 to be fully reconfigurable. For example, all of device 100 may be manufactured using flexible substrate circuit technology. Device 100 may then resemble, for example, a “placemat” or “napkin”-like flexible structure that is entirely deformable.

The example embodiment of device 100 illustrated in FIG. 1 is entirely deformable. Tablet configuration 100A allows the entirety of display 104 to be accessed in device 100. Tablet configuration 100A may be useful in situations where device 100 is at least temporarily stationary so that a user may, for example, watch presentations of stored or streamed media, execute productivity applications (e.g., word processing, spreadsheets, etc.) or perform other tasks that may be best facilitated by a large display area. Sensor circuitry in device 100 may comprise at least one sensor (generally “sensor 102”) and any circuitry that may be required to support the sensor. In the embodiment illustrated in FIG. 1, the sensor circuitry comprises three sensors 102A, 102B and 102C (collectively, “sensors 102A . . . C”) positioned on the display side of device 100. While only three sensors 102A . . . C are shown in FIG. 1, more or less sensors may be employed depending on, for example, the size and/or complexity of device 100, an intended use for device 100, etc. In general, sensors 102A . . . C may be visual capture sensors such as cameras, but other types of sensors (e.g., infrared (IR) sensors, etc.) are also possible. While in tablet configuration 100A, any one or all of sensors 102A . . . C may be active. For example, only one sensor may be used for basic visual capture, while two or more sensors may be employed for extended visual capture, depth sensing, etc.

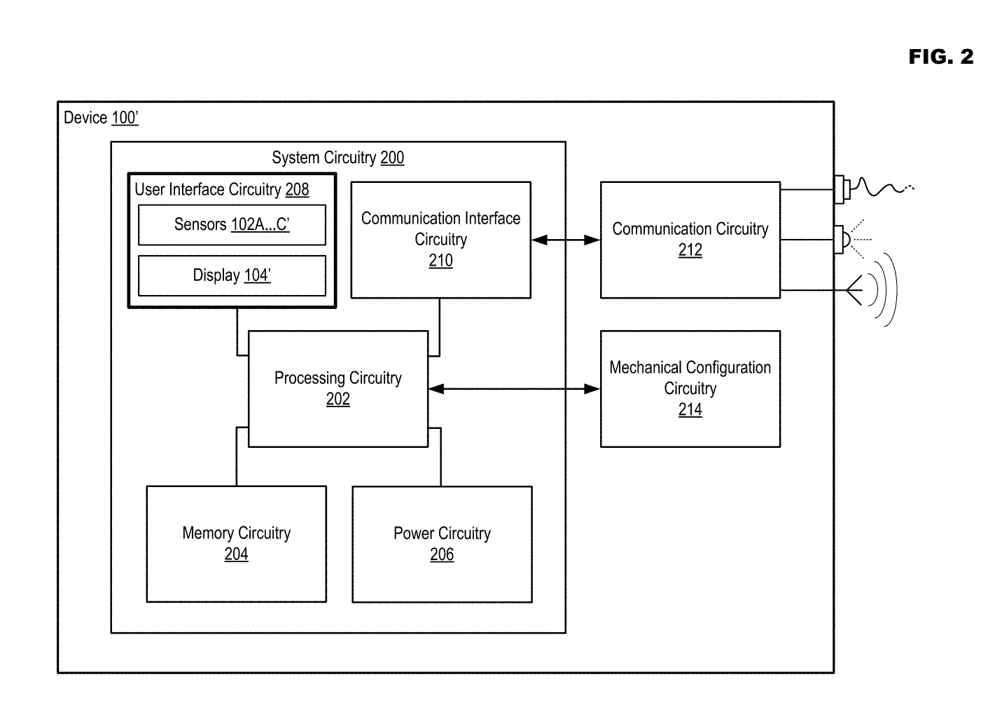

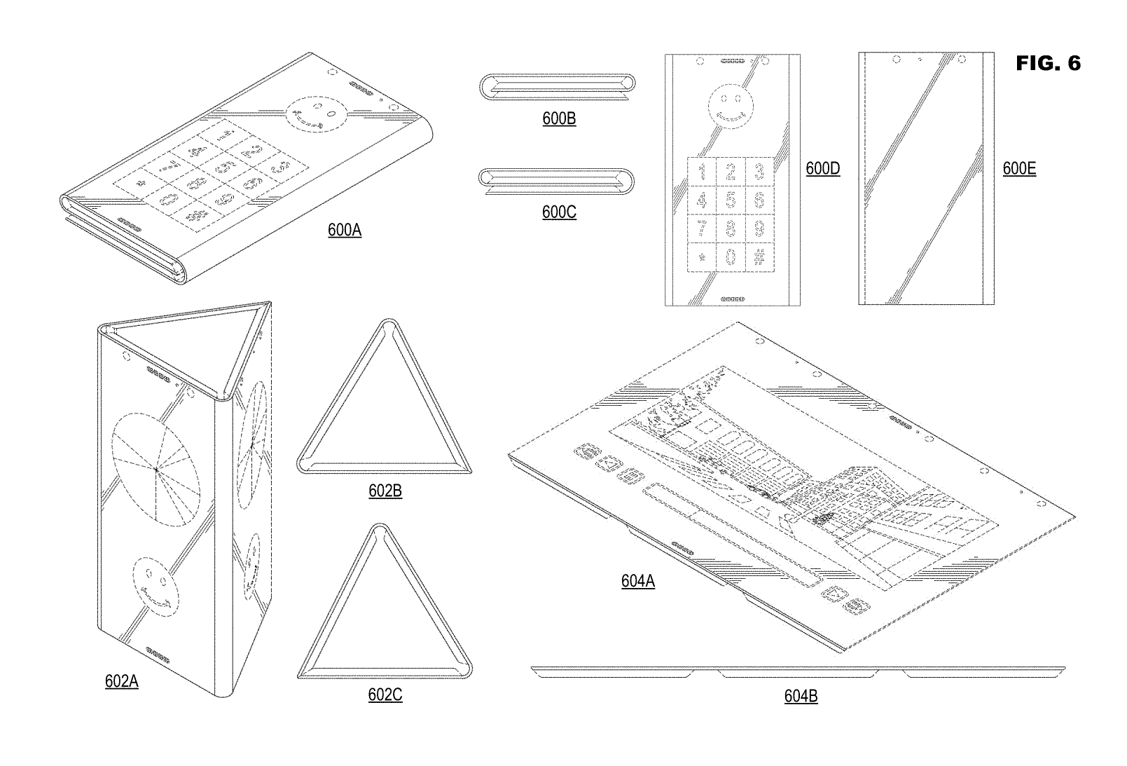

Device 100 may transform from tablet configuration 100A to mobile configuration 100B when, for example, a user wants to use device 100 on the go. In mobile configuration 100B the outer edges of at least display 104 may be folded backwards as shown at 108A and 108B (e.g., towards the “back” of device 100 away from the center of display 104). Mobile configuration 100B may comprise display 104B which is a portion of the entire display 104 that is visible to the user when holding the device. In at least one embodiment, display 104B may comprise a shape and size (e.g., form fact) similar to, for example, a smart phone display and may operate in a similar manner to a smart phone display. Sensor 102B may be visible to the user when holding device 100 in a typical manner and may be employed, for example, as a user-facing camera for self-captured visual data (e.g., “selfies”), video conferencing, etc. Depending on how the sides of device 100 overlap when in mobile configuration 100B, either sensor 102A or sensor 102C may be exposed in a position that faces away from the user (e.g., world-facing). In the example of FIG. 1, sensor 102C is world-facing and may be utilized to capture visual data similar to a world-facing camera in a smart phone or other mobile device. The operation of sensors 102A . . . C and display 104 (e.g., as smaller display 104B) may be configured automatically when device 100 is transformed from tablet configuration 100A into mobile configuration 100B. This will be discussed further in regard to FIGS. 2 and 6.

When not in use, device 100 may be transformed into inactive configuration 100C.

Instead of folding the edges of display 104 backwards as in mobile configuration 100B, in inactive configuration 100C the outer edges of at least display 104 are folded forward (e.g., towards the center of display 104) to enclose display 104 within outer housing 112 as shown at 108C and 108D. In inactive configuration 100C display 104 may be protected from being scratched, broken, etc. when being carried by the user (e.g., in a pocket, purse, etc.). In at least one embodiment, shape configuration changes in device 100 may be automatically detected, and when changed into inactive configuration 100C at least some systems in device 100 may be automatically placed into an inactive or sleep mode.

FIG. 2 illustrates an example configuration for a device usable in accordance with at least one embodiment of the present disclosure. For example, device 100' may be able to perform any or all of the activities shown in FIG. 1. However, device 100' is presented only as an example of an apparatus usable in embodiments consistent with the present disclosure, and is not intended to limit any of the embodiments to a particular manner of implementation.

System circuitry 200 may manage the operation of device 100'. System circuitry 200 may include, for example, processing circuitry 202, memory circuitry 204, power circuitry 206, user interface circuitry 208 and communication interface circuitry 210. Device 100' may also include communication circuitry 212 and shape configuration circuitry 214. While communication circuitry 212 and shape configuration circuitry 214 are illustrated as separate from system circuitry 200, the example in FIG. 2 is provided merely for the sake of explanation. Some or all of the functionality associated with communication circuitry 212 and/or shape configuration circuitry 214 may be incorporated into system circuitry 200.

In device 100', processing circuitry 202 may comprise one or more processors situated in separate components, or alternatively one or more processing cores in a single component (e.g., in a System-on-a-Chip (SoC) configuration), along with processor-related support circuitry (e.g., bridging interfaces, etc.). Example processors may include, but are not limited to, various x86-based microprocessors available from the Intel Corporation including those in the Pentium, Xeon, Itanium, Celeron, Atom, Quark, Core i-series, Core M-series product families, Advanced RISC (e.g., Reduced Instruction Set Computing) Machine or “ARM” processors, etc. Examples of support circuitry may include chipsets (e.g., Northbridge, Southbridge, etc. available from the Intel Corporation) configured to provide an interface through which processing circuitry 202 may interact with other system components that may be operating at different speeds, on different buses, etc. in device 100'. Moreover, some or all of the functionality commonly associated with the support circuitry may also be included in the same physical package as the processor (e.g., such as in the Sandy Bridge family of processors available from the Intel Corporation).

Processing circuitry 202 may be configured to execute various instructions in device 100'. Instructions may include program code configured to cause processing circuitry 202 to perform activities related to reading data, writing data, processing data, formulating data, converting data, transforming data, etc. Information (e.g., instructions, data, etc.) may be stored in memory circuitry 204. Memory circuitry 204 may comprise random access memory (RAM) and/or read-only memory (ROM) in a fixed or removable format. RAM may include volatile memory configured to hold information during the operation of device 100' such as, for example, static RAM (SRAM) or Dynamic RAM (DRAM). ROM may include non-volatile (NV) memory circuitry configured based on BIOS, UEFI, etc. to provide instructions when device 100' is activated, programmable memories such as electronic programmable ROMs (EPROMS), Flash, etc. Other examples of fixed/removable memory may include, but are not limited to, magnetic memories such as hard disk (HD) drives, electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), Digital Video Disks (DVD), Blu-Ray Disks, etc.

Power circuitry 206 may include internal power sources (e.g., a battery, fuel cell, etc.) and/or external power sources (e.g., electromechanical or solar generator, power grid, external fuel cell, etc.), and related circuitry configured to supply device 100' with the power needed to operate. User interface circuitry 208 may include hardware and/or software to allow users to interact with device 100' such as, for example, various input mechanisms (e.g., microphones, switches, buttons, knobs, keyboards, speakers, touch-sensitive surfaces, one or more sensors configured to capture images, video and/or sense proximity, distance, motion, gestures, orientation, biometric data, etc.) and various output mechanisms (e.g., speakers, displays, lighted/flashing indicators, electromechanical components for vibration, motion, etc.). The hardware in user interface circuitry 208 may be incorporated within device 100' and/or may be coupled to device 100' via a wired or wireless communication medium. At least some user interface circuitry 208 may be optional in certain circumstances such as, for example, a situation wherein device 100' is a very space-limited form factor device, a server (e.g., rack server or blade server), etc. that does not include user interface circuitry 208, and instead relies on another device (e.g., a management terminal) for user interface functionality.

Communication interface circuitry 210 may be configured to manage packet routing and other control functions for communication circuitry 212, which may include resources configured to support wired and/or wireless communications. In some instances, device 100' may comprise more than one set of communication circuitry 212 (e.g., including separate physical interface circuitry for wired protocols and/or wireless radios) managed by centralized communication interface circuitry 210. Wired communications may include serial and parallel wired mediums such as, for example, Ethernet, USB, Firewire, Thunderbolt, Digital Video Interface (DVI), High-Definition Multimedia Interface (HDMI), etc. Wireless communications may include, for example, close-proximity wireless mediums (e.g., radio frequency (RF) such as based on the RF Identification (RFID)or Near Field Communications (NFC) standards, infrared (IR), etc.), short-range wireless mediums (e.g., Bluetooth, WLAN, Wi-Fi, etc.), long range wireless mediums (e.g., cellular wide-area radio communication technology, satellite-based communications, etc.), electronic communications via sound waves, etc. In one embodiment, communication interface circuitry 210 may be configured to prevent wireless communications that are active in communication circuitry 212 from interfering with each other. In performing this function, communication interface circuitry 210 may schedule activities for communication circuitry 212 based on, for example, the relative priority of messages awaiting transmission. While the embodiment disclosed in FIG. 2 illustrates communication interface circuitry 210 being separate from communication circuitry 212, it may also be possible for the functionality of communication interface circuitry 210 and communication circuitry 212 to be incorporated into the same circuitry.

Consistent with the present disclosure, at least processing circuitry 202 may perform control operations within device 100'. For example, processing circuitry 202 may interact with memory circuitry 204 to load an operating system, drivers, utilities, applications, etc. to support operation of device 100.' Execution of the software may transform general purpose processing circuitry 202 into specialized circuitry to perform the activities described herein. For example, processing circuitry 202 may receive data about the shape configuration of device 100' from shape configuration circuitry 214, and may utilize the data to then configure sensor circuitry (e.g., sensors 102A . . . C', circuitry supporting sensors 102A . . . C, etc.) and/or display 104'. Shape configuration circuitry 214 may include, for example, at least one sensor to detect the position, orientation, rotation, angle, etc. of device 100', in general, or of at least one portion of device 100' with respect to at least one other portion of device 100'. This information may be utilized by processing circuitry 202 to determine, for example, whether device 100' is in a shape configuration involving visual capture, and if determined to be in a configuration involving visual capture, an operational mode for use in configuring sensors 102A . . . C' and/or display 104'. The operational mode may configure, for example, which sensors 102A . . . C are active (e.g., are capturing visual data), how each active sensor 102A . . . C will capture visual data (e.g., whether to capture image and/or video, field of view such as analog/digital focus and zoom, light sensitivity, image capture speed, number of images, image and/or video enhancement, flash mode, etc.), how the captured visual data will be processed (e.g., image and/or video format, filtering, enhancement, sizing, storage, etc.), how display 104' is configured (e.g., use all/part of display 104, the data will be presented on each part of display 104 being used, will touch be enabled on any or all of the parts of display 104 being used, display brightness, display resolution, etc.). Some or all of the operational mode may be set by, for example, the manufacturer of the sensing circuitry, a manufacturer of the device, by applications loaded on device 100', by user manual configuration, etc.

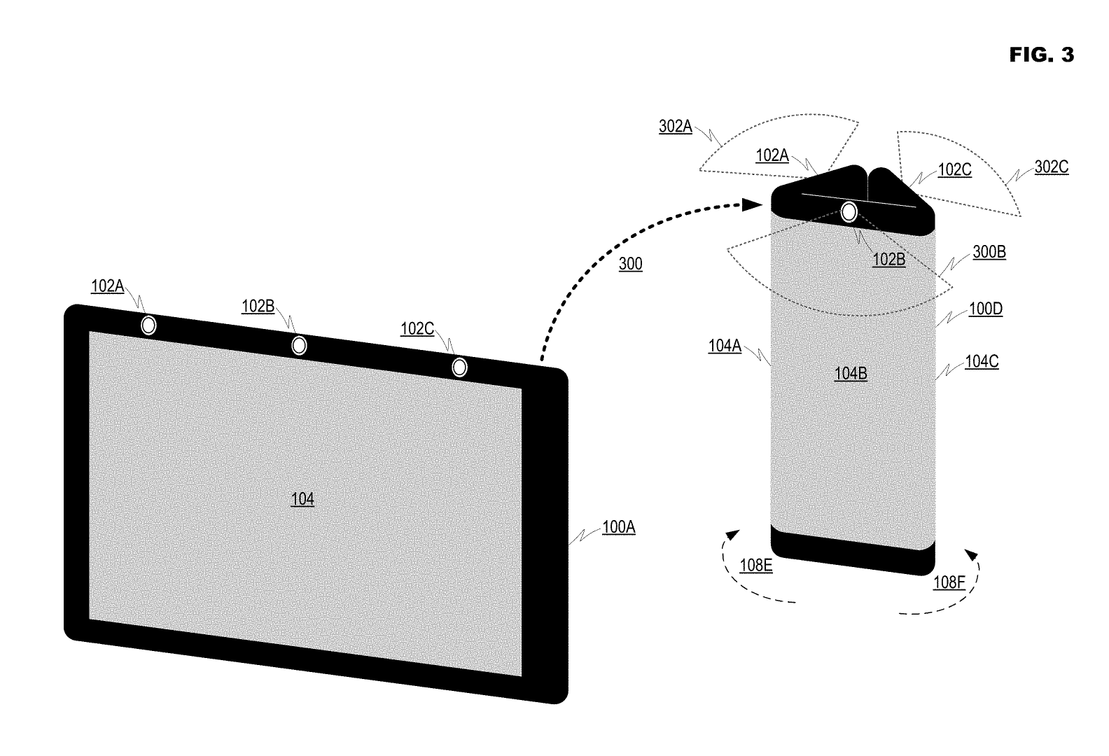

FIG. 3 illustrates an example reconfigurable device for extended visual capture in a first extended visual capture configuration in accordance with at least one embodiment of the present disclosure. A transition from tablet configuration 100A (e.g., as illustrated in FIG. 1) to first extended visual capture configuration 100D (hereafter, “FEVCC 100D”) is illustrated at 300 in FIG. 3. The shape configuration involved in transitioning to 1-ENCC 100D is similar to that of transitioning to mobile configuration 100B, but in FEVCC 100D the outer edges of at least display 104 are not folded back so that they overlap. Instead, the outer edges are folded back only to a point where they touch or are at least closely proximate a shown at 108E and 108F. In FEVCC 100D device 100 may have a columnar shape (e.g., a triangular column) that may be held by a user or stands independently on a flat surface such as a table.

In FIG. 3, fields of view for each of sensors 102A . . . C are shown at 302A, 302B and 302C, respectively (collectively, “fields of view 302A . . . C”). When device 100 is in FEVCC 100D, sensors 102A . . . C may be positioned so that the center of each field of view 302A . . . C is approximately 120 degrees apart. As a result, the combined fields of view 302A . . . C of all three sensors 102A . . . C may approach or achieve a full 360 degrees surrounding device 100. In this manner, FEVCC 100D may allow device 100 to capture visual data corresponding to events occurring anywhere around device 100, regardless of whether these events take place contemporaneously. In at least one embodiment, FEVCC 100D may cause display 104 to be configured to present combined visual data captured by all of sensors 102A . . . C in a manner that is aligned with the location of each sensors 102A . . . C (e.g., so that a user of device 100 may see the visual data that sensors 102A . . . C capture on display 104). Moreover, FEVCC 100D may allow device 100 to perform tasks that would not be possible with typical devices. For example, device 100 (e.g., while in FEVCC 100D) may be placed in the center of a table to perform a videoconference. The participants in the video conference may surround device 100 on all sides and be visible in the videoconference. This may provide a clearer picture of the faces of the videoconference participants since they are directly facing sensors 102A . . . C (e.g., instead of facing one distant camera). Moreover, FEVCC 100D, may cause display 104 to simulate three separate displays 104A, 104B and 104C (collectively, “displays 104A . . . C”) by presenting content in an area of display 104 that corresponds to the location of each sensor 102A . . . C. Displays 104A . . . C may be configured to present similar content (e.g., a remotely-located participant in the videoconference, an agenda, a presentation, etc.) or different content based on, for example, the viewer (e.g., a feedback stream for each sensor 102A . . . C showing participants how they look), the perspective of the viewer (e.g., different portions of a remote room may be shown based on the particular display 104A . . . C that the user is viewing), etc. Videoconferencing is one example of a potential usage consistent with the present disclosure. Other example usages may include, but are not limited to, security (e.g., device 100 may be placed in the middle of a room when in FEVCC 100D to sense for motion from intruders), high quality panoramic image or video capture at a live event, after a disaster or accident, etc.

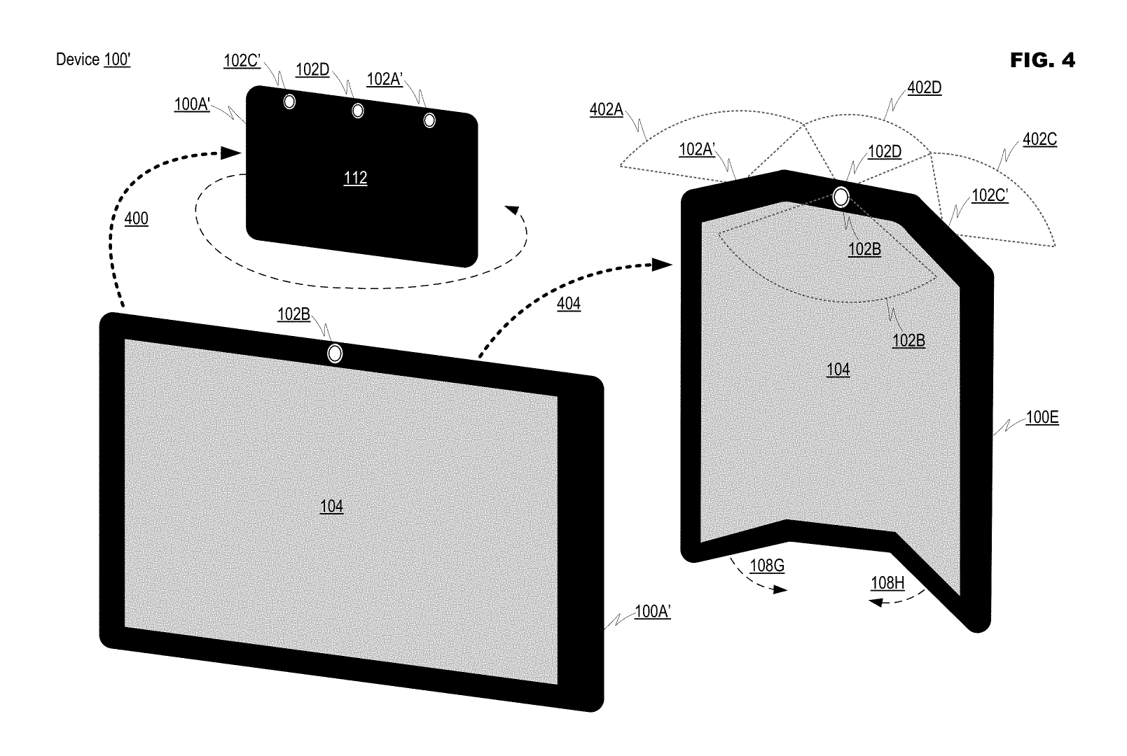

FIG. 4 illustrates an example reconfigurable device for extended visual capture in a second extended visual capture configuration in accordance with at least one embodiment of the present disclosure. Device 100' in FIG. 4 may include sensors 102A', 102B, 102C' and 102D. Similar to device 100 in FIG. 3, sensor 102B remains on the display side (e.g., front) of device 100'. However, as shown at 400 sensors 102C'and 102A' may be repositioned on the non-display side (e.g., back) of housing 112 along with sensor 102D. A transition from tablet configuration 100A' to second extended visual capture configuration 100E (hereafter, “SEVCC 100E”) is shown at 404 in FIG. 3. Contrary to the transition to FEVCC 100D in FIG. 3 wherein the outer edges of at least display 104 are folded outward, in transitioning to SEVCC 100E the outer edges of at least display 104 may fold inward (e.g., towards a center of display 104) a shown at 108G and 108H. As a result, while in SEVCC 100E device 100' may be deemed in a “book”-type configuration with the viewable surface of display 104 on the inside of the book.

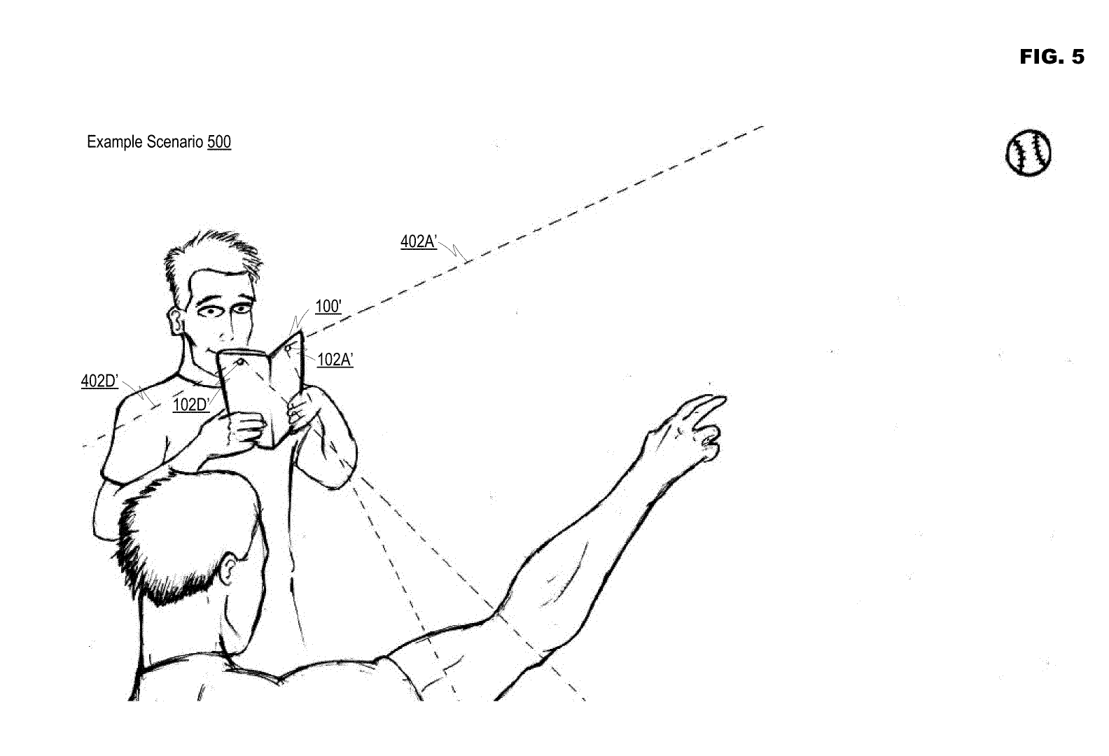

Fields of view 402A, 402B, 402C and 402D may correspond to sensors 102A', 102B, 102C' and 102D, respectively. All of sensors 102A', 102B, 102C' and 102D actively sensing may provide near 360 degrees of visual capture surrounding device 100'. Visual capture may be carried out concurrently for all of sensors 102A', 102B, 102C' and 102D, so activities that may occur contemporaneously in the area surrounding device 100' will all be captured. The resulting visual data may be consolidated into a single image, a video, etc. In an alternative mode of operation not all of sensors 102A', 102B, 102C' and 102D are active. An example of this mode of operation is presented in regard to FIG. 5.

FIG. 5 illustrates an example of extended visual capture using a reconfigurable device in accordance with at least one embodiment of the present disclosure. Example scenario 500 presented in FIG. 5 involves a person holding device 100' capturing another person throwing a baseball. The field of view in a typical mobile device (e.g., a smart phone, cellular handset, etc.) may not be wide enough to capture both the person throwing the baseball and the path of travel of the baseball itself. This issue may be resolved consistent with embodiments of the present disclosure. The shape configuration of device 100' has exposed sensors 102A' and 102D' for visual capture, and the person holding device 100' has directed sensors 102A' and 102D' towards the person throwing the baseball. The portion of at least display 104 that includes sensor 102C' is folded inward (e.g., towards display 104) in FIG. 5. There may be a variety of reasons for this shape configuration. The extended field of view required for visual capture of the desired action may not require three sensors, and folding this portion of device 100' inward may provide more stability to the user holding the device. Moreover, this shape configuration may cause control circuitry (e.g., at least processing circuitry 203) in device 100' to automatically deactivate sensor 102C' to, for example, conserve power in device 100', reduce the visual data processing burden n device 100', etc.

In FIG. 5, fields of view 402A' and 402D' may correspond to sensors 102A' and 102D', respectively. The resulting extended field of view may provide at least 180 degrees of visual capture surrounding device 100'. The extended field of view may allow for visual capture of the person throwing the baseball that includes both the activity of the person and the activity of the ball in flight. The capture may occur without the user holding device 100' having to move device 100', which may resolve temporal issues and increase capture quality.

FIG. 6 illustrates an example implementation of a device in accordance with at least one embodiment of the present disclosure. The various examples provided in FIG. 6 are to demonstrate possible implementations of device 100 from a strictly aesthetic perspective. Examples 600A to 600E illustrate device 100 in mobile configuration 100B. Example 600A shows a perspective view, example 600B shows a top view, example 600C shows a bottom view, example 600D shows a front view and example 600E shows a back view. Examples 602A to 602C illustrate device 100 in FEVCC 100D. Example 602A shows a perspective view, example 602B shows a top view and example 602C shows a bottom view. Examples 604A and 604B illustrate device 100 in tablet configuration 100A. Example 604A shows a perspective view and example 604B shows a bottom view. While a variety of examples are provided in FIG. 6 to demonstrate possible implementations of device 100 from a strictly aesthetic perspective, these examples are offered only for the sake of explanation and are not intended to limit the various embodiments disclosed herein to any particular type of aesthetic.

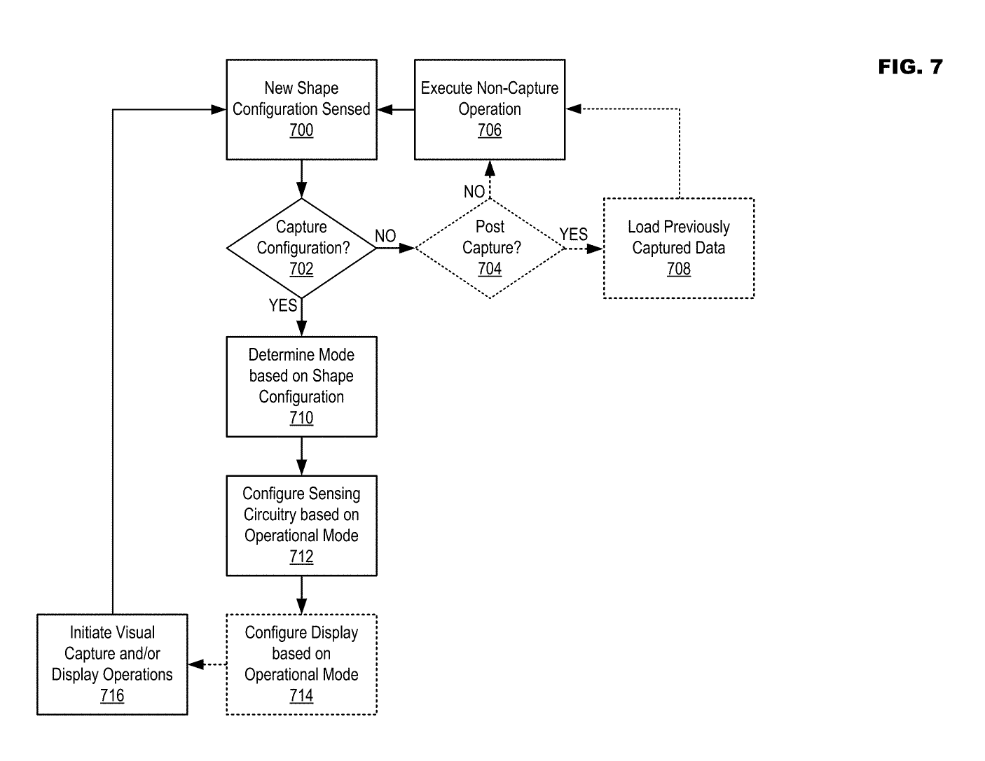

FIG. 7 illustrates example operations for extended visual capture in accordance with at least one embodiment of the present disclosure. Operations in FIG. 7 shown using dotted lines may be applicable only to certain implementations depending on, for example, a usage for which an implementation is intended, the capabilities of the equipment employed in the implementation, etc. In operation 700 a new shape configuration may be sensed for a device. A determination may be made in operation 702 as to whether the new shape configuration involves visual capture. Example shape configurations that may involve visual capture may include the FEVCC and the SEVCC shown in FIGS. 3 and 4, respectively. Example shape configurations that do not involve video capture (e.g., at least not as a primary function) may include the tablet, mobile or inactive configurations as shown in FIG. 1. If in operation 702 it is determined that the shape configuration does not involve visual capture, then in operation 704 a further determination may be made as to whether a prior shape configuration involved visual capture. If in operation 704 it is determined that the prior shape configuration did not involve visual capture, then in operation 706 non-capture-related operations may be executed related to the new shape configuration. Operation 706 may be followed by a return to operation 700 to continue sensing for further shape configuration changes in the device. If in operation 704 it is determined that the prior shape configuration involved visual capture, then in operation 708 at least visual data captured when in the prior shape configuration may be loaded prior to executing the non-capture operation in operation 706. For example, upon the device leaving SEVCC and entering tablet mode, at least the visual data captured when the device was in SEVCC may be loaded (e.g., along with software for viewing, editing, sharing, etc. the visual data).

If in operation 702 it is determined that the new shape configuration involves visual capture, then in operation 710 an operational mode may be determined based at least on the new shape configuration. In operation 712 sensing circuitry including at least one sensor may then be configured based on the operational mode determined in operation 710. Likewise, in operation 714 a display in the device may also be configured based on the operational mode determined in operation 710. Operation of the sensing circuitry and/or the display may then be initiated in operation 716. Operation 716 may be followed by a return to operation 700 to continue sensing for further shape configuration changes in the device.

While FIG. 7 illustrates operations according to an embodiment, it is to be understood that not all of the operations depicted in FIG. 7 are necessary for other embodiments. Indeed, it is fully contemplated herein that in other embodiments of the present disclosure, the operations depicted in FIG. 7, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, the present disclosure pertains to extended visual capture in a reconfigurable device. In general, at least a display portion of a device may have a deformable shape configuration in that it's shape is changeable by a user. The device may also comprise at least sensor circuitry including a plurality of sensors. The shape configuration may position the plurality of sensors at different positions to enable extended visual capture of a 180 to 360 degree viewing range surrounding the device in a single image or video. Control circuitry in the device may determine when shape reconfiguration of at least the display has occurred, determine whether the new shape configuration involves visual capture, and if the new shape configuration is determined to involve visual capture, determine an operational mode for the at least the sensor circuitry and cause the sensor circuitry to capture visual data based at least on the operational mode.

The following examples pertain to further embodiments. The following examples of the present disclosure may comprise subject material such as a device, a method, at least one machine-readable medium for storing instructions that when executed cause a machine to perform acts based on the method, means for performing acts based on the method and/or a system for extended visual capture in a reconfigurable device.

According to example 1 there is provided a visual data capture device. The device may comprise a deformable display having a shape configuration, sensor circuitry to capture at least visual data and control circuitry to determine that the display has changed to a new shape configuration, determine if the new shape configuration involves visual data capture and, based on a determination that the new shape configuration involves visual data capture, determine an operational mode for at least the sensor circuitry based on the new shape configuration and cause the sensor circuitry to capture visual data based at least on the operational mode.

Example 2 may include the elements of example 1, wherein the shape configuration comprises at least a first portion of the display being oriented relative to a second portion of the display.

Example 3 may include the elements of any of examples 1 to 2, wherein at least the display is flexible.

Example 4 may include the elements of example 3, wherein the display is manufactured using flexible substrate circuitry.

Example 5 may include the elements of any of examples 1 to 4, wherein the display is segmented into portions, the portions being at least mechanically coupled to allow the display portions to move relative to each other.

Example 6 may include the elements of any of examples 1 to 5, wherein the new shape configuration comprises at least two opposing end portions of the display folded away from a center of a presentation surface of the display so that at least the display becomes substantially columnar in shape with the presentation surface visible on an outer surface of the columnar shape.

Example 7 may include the elements of any of examples 1 to 6, wherein the new shape configuration comprises at least two opposing end portions of the display folded towards a center of a presentation surface of the display so that the presentation surface is visible on the interior of the folded display.

Example 8 may include the elements of any of examples 1 to 7, wherein the sensor circuitry comprises a plurality of sensors.

Example 9 may include the elements of example 8, wherein the plurality of sensors comprise at least cameras.

Example 10 may include the elements of any of examples 8 to 9, wherein the operational mode is to cause certain sensors in the plurality of sensors to capture the visual data based on the shape configuration.

Example 11 may include the elements of example 10, wherein the certain sensors are mounted to a surface of the display, the certain sensors being positioned for visual data capture by deforming the display.

Example 12 may include the elements of example 11, wherein the certain sensors are mounted to a front surface of the display and a rear surface of the display.

Example 13 may include the elements of any of examples 8 to 12, wherein the shape configuration of at least the display causes the plurality of sensors to be positioned with respect to each other to capture visual data corresponding to at least a 180 degree viewing range surrounding the device.

Example 14 may include the elements of any of examples 8 to 13, wherein the shape configuration of at least the display causes the plurality of sensors to be positioned with respect to each other to capture visual data corresponding to substantially a 360 degree viewing range surrounding the device.

Example 15 may include the elements of any of examples 1 to 14, wherein the control circuitry is to configure operation of the display based on the operational mode.

Example 16 may include the elements of any of examples 1 to 15, wherein at least the display is flexible or segmented into portions, the portions being at least mechanically coupled to allow the display portions to move relative to each other.

Example 17 may include the elements of any of examples 1 to 16, wherein the sensor circuitry comprises a plurality of sensors and the control circuitry is to cause certain sensors in the plurality of sensors to capture the visual data based on the shape configuration.

Example 18 may include the elements of any of examples 1 to 17, wherein in capturing visual data the sensor circuitry is to perform extended visual capture.

According to example 19 there is provided a method for controlling a visual data capture device. The method may comprise determining that a deformable display having a shape configuration in a device has changed to a new shape configuration, determining if the new shape configuration involves visual data capture and, based on a determination that the new shape configuration involves visual data capture, configuring an operational mode for at least sensor circuitry in the device based on the shape configuration and causing the sensor circuitry to capture the visual data based on the operational mode.

Example 20 may include the elements of example 19, wherein the shape configuration comprises at least a first portion of the display being oriented relative to a second portion of the display.

Example 21 may include the elements of any of examples 19 to 20, wherein configuring an operational mode for the sensor circuitry comprises configuring the operation of a plurality of sensors in the sensor circuitry.

Example 22 may include the elements of example 21, wherein configuring the operation of the plurality of sensors comprises causing certain sensors in the plurality of sensors to capture the visual data based on the shape configuration.

Example 23 may include the elements of any of examples 19 to 22, and may further comprise configuring operation of the display based on the operational mode.

Example 24 may include the elements of any of examples 19 to 23, and may further comprise, based on a determination that the new shape configuration does not involve visual data capture, executing a non-capture operation based on the capture configuration.

Example 25 may include the elements of any of examples 19 to 24, and may further comprise, based on a determination that the new shape configuration does not involve visual data capture, determining whether a previous shape configuration involved visual data capture and, based on a determination that the previous shape configuration involved visual data capture, at least loading previously captured visual data and displaying the previously captured visual data on the display.

Example 26 may include the elements of example 25, and may further comprise, based on a determination that the previous shape configuration involved visual data capture, further loading software for viewing, editing or sharing the visual data.

Example 27 may include the elements of any of examples 19 to 26, and may further comprise, based on a determination that the new shape configuration does not involve visual data capture, executing a non-capture operation based on the capture configuration, based on a determination that the new shape configuration does not involve visual data capture, determining whether a previous shape configuration involved visual data capture and, based on a determination that the previous shape configuration involved visual data capture, at least loading previously captured visual data and displaying the previously captured visual data on the display.

Example 28 may include the elements of any of examples 19 to 27, wherein causing the sensor circuitry to capture visual data comprises causing the sensor circuitry to perform extended visual capture.

According to example 29 there is provided a system including at least one device, the system being arranged to perform the method of any of the above examples 19 to 28.

According to example 30 there is provided a chipset arranged to perform the method of any of the above examples 19 to 28.

According to example 31 there is provided at least one machine readable medium comprising a plurality of instructions that, in response to be being executed on a computing device, cause the computing device to carry out the method according to any of the above examples 19 to 28.

According to example 32 there is provided a device capable of visual data capture, the device being arranged to perform the method of any of the above examples 19 to 28.

According to example 33 there is provided a system for controlling a visual data capture. The system may comprise means for determining that a deformable display having a shape configuration in a device has changed to a new shape configuration, means for determining if the new shape configuration involves visual data capture and means for, based on a determination that the new shape configuration involves visual data capture, configuring an operational mode for at least sensor circuitry in the device based on the shape configuration and causing the sensor circuitry to capture the visual data based on the operational mode.

Example 34 may include the elements of example 33, wherein the shape configuration comprises at least a first portion of the display being oriented relative to a second portion of the display.

Example 35 may include the elements of any of examples 33 to 34, wherein the means for configuring an operational mode for the sensor circuitry comprise means for configuring the operation of a plurality of sensors in the sensor circuitry.

Example 36 may include the elements of example 35, wherein the means for configuring the operation of the plurality of sensors comprise means for causing certain sensors in the plurality of sensors to capture the visual data based on the shape configuration.

Example 37 may include the elements of any of examples 33 to 36, and may further comprise means for configuring operation of the display based on the operational mode.

Example 38 may include the elements of any of examples 33 to 37, and may further comprise means for, based on a determination that the new shape configuration does not involve visual data capture, executing a non-capture operation based on the capture configuration.

Example 39 may include the elements of any of examples 33 to 38, and may further comprise means for, based on a determination that the new shape configuration does not involve visual data capture, determining whether a previous shape configuration involved visual data capture and means for, based on a determination that the previous shape configuration involved visual data capture, at least loading previously captured visual data and display the previously captured visual data on the display.

Example 40 may include the elements of example 39, and may further comprise means for, based on a determination that the previous shape configuration involved visual data capture, further loading software for viewing, editing or sharing the visual data.

Example 41 may include the elements of any of examples 33 to 40, and may further comprise means for, based on a determination that the new shape configuration does not involve visual data capture, executing a non-capture operation based on the capture configuration, means for, based on a determination that the new shape configuration does not involve visual data capture, determining whether a previous shape configuration involved visual data capture and means for, based on a determination that the previous shape configuration involved visual data capture, at least loading previously captured visual data and displaying the previously captured visual data on the display.

Example 42 may include the elements of any of examples 33 to 41, wherein the means for causing the sensor circuitry to capture visual data comprise means for causing the sensor circuitry to perform extended visual capture.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-25. (canceled)

26. A visual data capture device, comprising:
a deformable display having a shape configuration;
sensor circuitry to capture at least visual data; and
control circuitry to determine that the display has changed to a new shape configuration, determine if the new shape configuration involves visual data capture and, based on a determination that the new shape configuration involves visual data capture, determine an operational mode for at least the sensor circuitry based on the new shape configuration and cause the sensor circuitry to capture visual data based at least on the operational mode.

27. The device of claim 26, wherein the shape configuration comprises at least a first portion of the display being oriented relative to a second portion of the display.

28. The device of claim 26, wherein at least the display is flexible.

29. The device of claim 26, wherein the display is segmented into portions, the portions being at least mechanically coupled to allow the display portions to move relative to each other.

30. The device of claim 26, wherein the new shape configuration comprises at least two opposing end portions of the display folded away from a center of a presentation surface of the display so that at least the display becomes substantially columnar in shape with the presentation surface visible on an outer surface of the columnar shape.

31. The device of claim 26, wherein the new shape configuration comprises at least two opposing end portions of the display folded towards a center of a presentation surface of the display so that the presentation surface is visible on the interior of the folded display.

32. The device of claim 26, wherein the sensor circuitry comprises a plurality of sensors.

33. The device of claim 32, wherein the operational mode is to cause certain sensors in the plurality of sensors to capture the visual data based on the shape configuration.

34. The device of claim 32, wherein the shape configuration of at least the display causes the plurality of sensors to be positioned with respect to each other to capture visual data corresponding to at least a 180 degree viewing range surrounding the device.

35. The device of claim 32, wherein the shape configuration of at least the display causes the plurality of sensors to be positioned with respect to each other to capture visual data corresponding to substantially a 360 degree viewing range surrounding the device.

36. The device of claim 26, wherein the control circuitry is to configure operation of the display based on the operational mode.

37. A method for controlling a visual data capture device, comprising:
determining that a deformable display having a shape configuration in a device has changed to a new shape configuration;
determining if the new shape configuration involves visual data capture; and
based on a determination that the new shape configuration involves visual data capture, configuring an operational mode for at least sensor circuitry in the device based on the shape configuration and causing the sensor circuitry to capture the visual data based on the operational mode.

38. The method of claim 37, wherein the shape configuration comprises at least a first portion of the display being oriented relative to a second portion of the display.

39. The method of claim 37, wherein configuring an operational mode for the sensor circuitry comprises configuring the operation of a plurality of sensors in the sensor circuitry.

40. The method of claim 39, wherein configuring the operation of the plurality of sensors comprises causing certain sensors in the plurality of sensors to capture the visual data based on the shape configuration.

41. The method of claim 37, further comprising:
configuring operation of the display based on the operational mode.

42. The method of claim 37, further comprising:
based on a determination that the new shape configuration does not involve visual data capture, executing a non-capture operation based on the capture configuration.

43. The method of claim 37, further comprising:
based on a determination that the new shape configuration does not involve visual data capture, determining whether a previous shape configuration involved visual data capture; and
based on a determination that the previous shape configuration involved visual data capture, at least loading previously captured visual data and displaying the previously captured visual data on the display.

44. At least one machine-readable storage medium having stored thereon, individually or in combination, instructions for controlling a visual data capture device that, when executed by one or more processors, cause the one or more processors to:
determine that a deformable display having a shape configuration in a device has changed to a new shape configuration;
determine if the new shape configuration involves visual data capture; and
based on a determination that the new shape configuration involves visual data capture, configure an operational mode for at least sensor circuitry in the device based on the shape configuration and cause the sensor circuitry to capture the visual data based on the operational mode.

45. The storage medium of claim 44, wherein the shape configuration comprises at least a first portion of the display being oriented relative to a second portion of the display.

46. The storage medium of claim 44, wherein the instructions to configure an operational mode for the sensor circuitry comprise instructions to configure the operation of a plurality of sensors in the sensor circuitry.

47. The storage medium of claim 46, wherein the instructions to configure the operation of the plurality of sensors comprise instructions to cause certain sensors in the plurality of sensors to capture the visual data based on the shape configuration.

48. The storage medium of claim 44, further comprising instructions that, when executed by one or more processors, cause the one or more processors to:
configure operation of the display based on the operational mode.

49. The storage medium of claim 44, further comprising instructions that, when executed by one or more processors, cause the one or more processors to:
based on a determination that the new shape configuration does not involve visual data capture, execute a non-capture operation based on the capture configuration.

50. The storage medium of claim 44, further comprising instructions that, when executed by one or more processors, cause the one or more processors to:
based on a determination that the new shape configuration does not involve visual data capture, determine whether a previous shape configuration involved visual data capture; and
based on a determination that the previous shape configuration involved visual data capture, at least load previously captured visual data and display the previously captured visual data on the display.
